(19) United States
(12) Patent Application Publication
(10) Pub. No.: US 2014/0225373 A1
(43) Pub. Date: Aug. 14, 2014

(54) ELECTRIC MACHINE WITH DAMPENING MEANS

(71) Applicant: ABB Technology AG, Zurich (CH)

(72) Inventors: Janne Roivainen, Tuusula (FI); Juhani Mantere, Tuusula (FI); Aron Szucs, Helsinki (FI)

(73) Assignee: ABB Technology AG, Zurich (CH)

(21) Appl. No.: 14/255,644

(22) Filed: Apr. 17, 2014

Related U.S. Application Data
(63) Continuation of application No. PCT/FI2012/050989, filed on Oct. 16, 2012.

(30) Foreign Application Priority Data
Oct. 17, 2011 (EP) 11185420.4

(51) Int. Cl. H02K 5/24; F03D 9/00

(52) U.S. Cl. CPC H02K 5/24; F03D 9/002
USPC 290/55; 310/51

(57) ABSTRACT

An electric machine includes a support frame, an outer rotor, a stator, and a dampening mechanism. The outer rotor and the stator are supported to the support frame, and the dampening mechanism is configured for dampening vibrations of the outer rotor. The outer rotor includes an annular end plate, and the dampening mechanism includes a first damper having a first constraint element and a first visco-elastic layer provided on a surface of the first constraint element. The first constraint element is connected to the annular end plate through the first visco-elastic layer.

### RELATED APPLICATIONS

This application claims priority as a continuation application under 35 U.S.C. §120 to PCT/FI2012/050989, which was filed as an International Application on Oct. 16, 2012 designating the U.S., and which claims priority to European Application 11185420.4 filed in Europe on Oct. 17, 2011. The entire contents of these applications are hereby incorporated by reference in their entireties.

### FIELD

The present disclosure relates to suppression of vibrations in a rotating electric machine.

### BACKGROUND

Vibrations of a rotating electric machine may have several different sources such as unbalance in a rotor, magnetic forces due to imperfect magnetic design, external excitation, or magnetic forces caused by air-gap anomalies due to overhang of an outer rotor of the rotating electric machine combined with gravitational pull.

Vibrations cause significant problems in known rotating electric machines. Vibrations may cause excessive noise. Vibrations may also shorten operating life of rotating electric machines.

The present disclosure utilizes a constrained-layer damping technique which is described, for example, in the following documents.

[1] Cremer, L. & Heckl, M. & Ungar, E. E., 1987. Structure-Borne Sound. 2nd ed. Berlin: Springer Verlag.

[2] Ewins, D. J., 2001. Modal Testing, Theory, Practice, and Application. 2nd ed. Hertfordshire, England: Research Studies Press ltd.

[3] Garibaldi, L. & Onah, H. N., 1996. Viscoelastic Material Damping Technology. Torino: Becchis Osiride.

There exist a great number of mathematical formulations to describe the dampening mechanisms of a material. Herein, a hysteretical damping model is used. The hysteretical damping model is also called as a structural damping model. For hysteretically damped isotropic material, the complex Young's modulus E* and Shear modulus G* are defined as

E*=E(1+jη)

G*=G(1+jη),

where E is the real Young's modulus, G is the real shear modulus and n is the material loss factor. The above definitions can be found in reference [3], on page 30.

### SUMMARY

An exemplary embodiment of the present disclosure provides an electric machine which includes a support frame, an outer rotor, a stator, and dampening means. The outer rotor and the stator are supported to the support frame. The dampening means is configured for dampening vibrations of the outer rotor. The outer rotor includes an annular end plate. The dampening means comprises a first damper having a first constraint element and a first visco-elastic layer provided on a surface of the first constraint element. The first constraint element is connected to the annular end plate through the first visco-elastic layer.

An exemplary embodiment of the present disclosure provides an electric machine which includes a support frame, an outer rotor, a stator, and dampening means. The outer rotor and the stator are supported to the support frame. The dampening means is configured for dampening vibrations of the outer rotor. The outer rotor includes an annular end plate. The dampening means comprises a first damper having a first constraint element and a first visco-elastic layer provided on a surface of the first constraint element. The first constraint element is connected to the annular end plate through the first visco-elastic layer. The outer rotor is supported to the support frame exclusively at one end by a bearing located at an opposed end of the outer rotor relative to the annular end plate.

### BRIEF DESCRIPTION OF THE DRAWINGS

Additional refinements, advantages and features of the present disclosure are described in more detail below with reference to exemplary embodiments illustrated in the drawings, in which:

FIG. 1 shows a cross section of an electric machine according to an exemplary embodiment of the present disclosure;

FIG. 2A shows dampening means of the electric machine of FIG. 1, according to an exemplary embodiment of the present disclosure;

FIG. 2B shows dampening means of an electric machine according to an exemplary embodiment of the present disclosure; and

FIG. 2C shows dampening means of an electric machine according to an exemplary embodiment of the present disclosure.

### DETAILED DESCRIPTION

Exemplary embodiments of the present disclosure provide an outer rotor electric machine which alleviates the above-described vibration problems associated with known techniques.

Exemplary embodiments of the present disclosure are based on the idea of providing an outer rotor of an electric machine with one or more dampers connected to an annular end plate of the outer rotor, where the one or more dampers utilize a constrained-layer damping technique.

An advantage of the present disclosure is that vibrations of an outer rotor electric machine may be suppressed thereby reducing noise and extending the operating life of the electric machine.

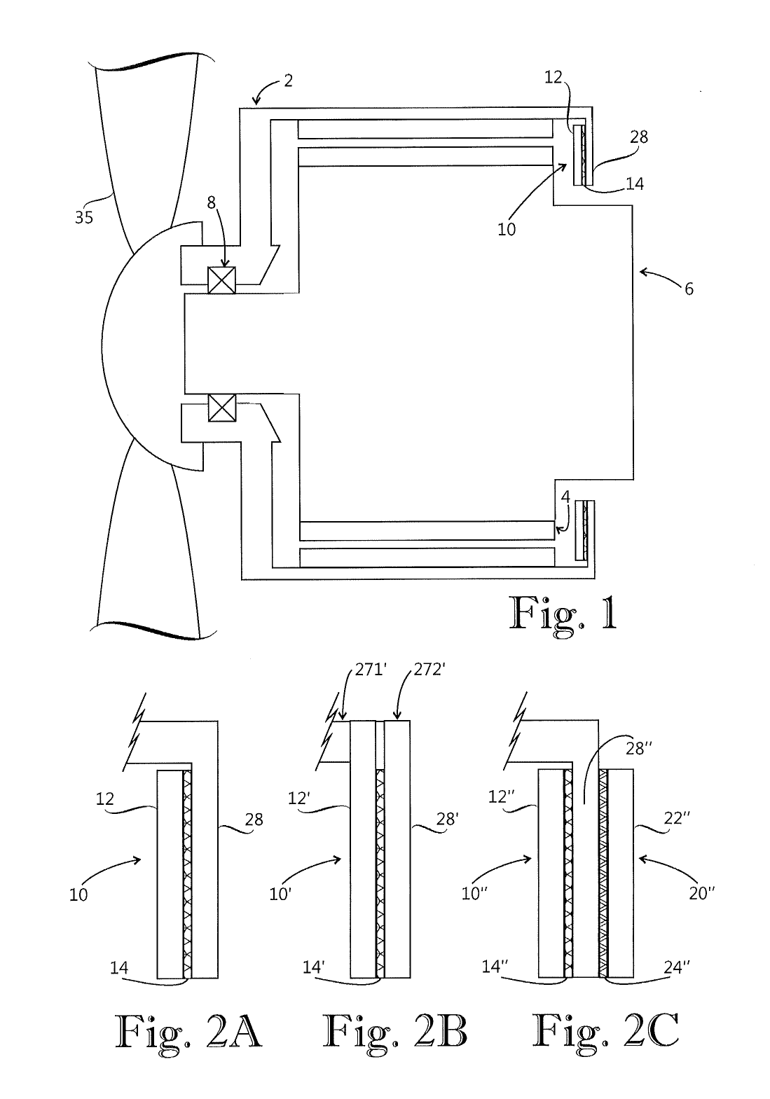

FIG. 1 shows an electric machine including a support frame 6, an outer rotor 2, a stator 4, and dampening means. The outer rotor 2 and the stator 4 are supported to the support frame 6. The stator 4 is immovably supported to the support frame 6, whereas the outer rotor 2 is rotatably supported to the support frame 6. The dampening means is configured for dampening vibrations of the outer rotor. As used herein, an outer rotor refers to a rotor that is located radially farther from a center line of an electric machine than the stator of the electric machine.

FIG. 2A is an enlargement showing an exemplary embodiment of the dampening means of the electric machine of FIG. 1. The dampening means include a first damper 10 having a first constraint element 12 and a first visco-elastic layer 14 provided on a surface of the first constraint element 12. The first constraint element 12 is connected to the outer rotor through the first visco-elastic layer 14. The first damper 10 is configured for damping radial vibrations of the outer rotor 2. The first constraint element 12 is a monolithic element having the form of an annular ring. Also, the first visco-elastic layer 14 has the form of an annular ring. The first constraint element 12 may be manufactured from steel or aluminium, for example. In embodiments where it is not possible to construct a first constraint element as a monolithic element, the parts of the first constraint element should be joined together rigidly.

The outer rotor 2 includes an annular end plate 28, the first damper 10 being connected to the annular end plate 28. The annular end plate 28 may be made of steel or aluminium. A symmetry axis of the annular end plate 28 coincides with rotation axis of the outer rotor 2. Thus a plane defined by the annular end plate 28 extends perpendicular to the rotation axis of outer rotor 2.

The outer rotor 2 is supported to the support frame 6 exclusively at one end by a bearing 8 located at an opposed end of the outer rotor 2 relative to the annular end plate 28. The bearing 8 may comprise one or more bearing units. A bearing unit may comprise for example a ball bearing or a cylindrical bearing.

The annular end plate 28 and the bearing 8 are spaced apart in axial direction of the outer rotor machine. Active parts of the outer rotor 2 and the stator 4 are situated between the annular end plate 28 and the bearing 8 when seen in the axial direction, the active parts being the components configured to interact magnetically during operation of the machine.

The proper design method, also known as Master Curve Procedure using International Plot, for optimizing the damping capacity vs. temperature and frequency is explained thoroughly in reference [3], on pages 101-110. The reference [3], which is identified in section Background of the Disclosure, discloses that the material loss factor has a property of reaching a maximum value at certain temperature and frequency. In other words the material loss factor is a function on temperature and frequency.

To ensure an adequate damping capacity of the first damper 10 maximum loss factor η_{fvel}_{_{—}}ₘₐₓ of the first visco-elastic layer 14 is greater than or equal to 0.7. Both the maximum loss factor η_{fce}_{_{—}}ₘₐₓ of the first constraint element 12 and the maximum loss factor η_{vpc}_{_{—}}ₘₐₓ of the outer rotor 2 are substantially less than the maximum loss factor η_{fvel}_{_{—}}ₘₐₓ of the first visco-elastic layer 14.

In an alternative embodiment maximum loss factor of the first visco-elastic layer is greater than or equal to 0.9. Basically, the higher the maximum loss factor of a visco-elastic layer is the more effective the damping is.

In the embodiment shown in FIG. 1 the outer rotor 2 is a one-piece component, the annular end plate 28 being an integral part of the outer rotor 2. The first constraint element 12 is connected to the outer rotor 2 exclusively through the first visco-elastic layer 14. There are no bolts, screws or other stiff particles connecting the first constraint element 12 to the outer rotor 2. The first visco-elastic layer 14 is a one-piece layer.

FIG. 2B shows dampening means of an electric machine according to an exemplary embodiment of the present disclosure. In FIG. 2B the outer rotor includes a first portion 271′ and a second portion 272′. The first damper 10′ is located between the first portion 271′ of the outer rotor and the second portion 272′ of the outer rotor such that the first damper 10′ separates the first portion 271′ of the outer rotor from the second portion 272′ of the outer rotor. The second portion 272′ of the outer rotor is connected to the first constraint element 12′ through the first visco-elastic layer 14′. The first portion 271′ of the outer rotor includes a cylindrical body. The first constraint element 12′ is joined rigidly to the first portion 271′ of the outer rotor, for example, by welding or by screws. Alternatively, the first constraint element 12′ may be an integral part of the first portion 271′ of the outer rotor. The second portion 272′ of the outer rotor includes an annular end plate 28′.

FIG. 2C shows dampening means of an electric machine according to an exemplary embodiment of the present disclosure. The dampening means of FIG. 2C includes a first damper 10″ and a second damper 20″ connected to an annular end plate 28″ of an outer rotor. The first damper 10″ includes a first constraint element 12″ and a first visco-elastic layer 14″ provided on a surface of the first constraint element 12″. The first constraint element 12″ is connected to the annular end plate 28″ through the first visco-elastic layer 14″. The second damper 20″ includes a second constraint element 22″ and a second visco-elastic layer 24″ provided on a surface of the second constraint element 22″. The second constraint element 22″ is connected to the outer rotor through the second visco-elastic layer 24″. Both the first constraint element 12″ and the second constraint element 22″ are substantially annular components. The annular end plate 28″ is sandwiched between the first damper 10″ and the second damper 20″.

Both the maximum loss factor η_{fvel-2}_{_{—}}ₘₐₓ of the first visco-elastic layer 14″ and the maximum loss factor ηₛᵥₑₗ₋₂_{_{—}}ₘₐₓ of the second visco-elastic layer 24″ are greater than or equal to 0.7. The maximum loss factor η_{fce-2}_{_{—}}ₘₐₓ of the first constraint element 12″, the maximum loss factor η_{sce-2} of the second constraint element 22″ and the maximum loss factor η_{vpc-2}_{_{—}}ₘₐₓ of the outer rotor each are substantially less than 0.7.

According to an exemplary embodiment, the first damper 10″ is optimized for a first temperature T₁ and a first frequency f₁. The second damper 20″ is optimized for a second temperature T₂ and a second frequency f₂. The second temperature T₂ is different from the first temperature T₁, and the second frequency f₂ is different from the first frequency f₁. Herein, a damper is considered to be optimized for a certain temperature and a certain frequency if the material loss factor of the visco-elastic layer of the damper reaches its maximum value at said temperature and frequency.

Dampening means including a plurality of dampers may be configured such that each of the dampers is optimized for a different temperature-frequency pair than rest of the dampers. Thereby maximum dampening range of the dampening means may be widened.

In the exemplary embodiment of FIG. 1, the outer rotor electric machine is configured as an electric generator of a wind power plant. The outer rotor 2 is configured to be in direct contact with the surrounding air. Blades 35 of a wind turbine are located at the same end of the outer rotor 2 as the bearing 8. In FIG. 1, the blades 35 are depicted only partially. In an alternative embodiment, an electric machine according to the present disclosure is configured as a belt-roller motor configured to be used in heavy steel industry.

An annular end plate of an outer rotor of a wind generator may be equipped with a brake disc for braking the outer rotor. The first damper may be located outer in radial direction than the brake disc. In some cases it is possible to retrofit a first damper according to present disclosure to an annular end plate of an outer rotor of an existing wind generator.

It will be obvious to a person skilled in the art that the inventive concept can be implemented in various ways. The present disclosure and its embodiments are not limited to the examples described above but may vary within the scope of the claims.

It will therefore be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein

1. An electric machine comprising:
a support frame;
an outer rotor;
a stator; and
dampening means, wherein:
the outer rotor and the stator are supported to the support frame;
the dampening means is configured for dampening vibrations of the outer rotor;
the outer rotor comprises an annular end plate;
the dampening means comprises a first damper having a first constraint element and a first visco-elastic layer provided on a surface of the first constraint element; and
the first constraint element is connected to the annular end plate through the first visco-elastic layer.

2. An electric machine according to claim 1, wherein the outer rotor is supported to the support frame exclusively at one end by a bearing located at an opposed end of the outer rotor relative to the annular end plate.

3. An electric machine according to claim 1, wherein the maximum loss factor of the first visco-elastic layer is greater than or equal to 0.7.

4. An electric machine as claimed in claim 1, wherein the maximum loss factor of the first constraint element is substantially less than the maximum loss factor of the first visco-elastic layer.

5. An electric machine as claimed in claim 1, wherein the maximum loss factor of the outer rotor is substantially less than the maximum loss factor of the first visco-elastic layer.

6. An electric machine as claimed in claim 1, wherein the first constraint element is a monolithic element.

7. An electric machine as claimed in claim 1, wherein the first constraint element is connected to the outer rotor exclusively through the first visco-elastic layer.

8. An electric machine as claimed in claim 1, wherein:
the outer rotor comprises a first portion and a second portion;
the first damper is located between the first portion of the outer rotor and the second portion of the outer rotor such that the first damper separates the first portion of the outer rotor from the second portion of the outer rotor; and
the second portion of the outer rotor is connected to the first constraint element through the first visco-elastic layer.

9. An electric machine as claimed in claim 1, wherein the dampening means further comprises a second damper having a second constraint element and a second visco-elastic layer provided on a surface of the second constraint element, the second constraint element being connected to the outer rotor through the second visco-elastic layer.

10. An electric machine according to claim 9, wherein the first damper is optimized for a first temperature and a first frequency, and the second damper is optimized for a second temperature and a second frequency, the second temperature being different from the first temperature, and the second frequency being different from the first frequency.

11. A wind power plant for converting wind energy into electric energy, the wind power plant comprising an electric generator, wherein the electric generator is an electric machine according to claim 1.

12. An electric machine comprising:
a support frame;
an outer rotor;
a stator; and
dampening means, wherein:
the outer rotor and the stator are supported to the support frame;
the dampening means is configured for dampening vibrations of the outer rotor;
the outer rotor comprises an annular end plate;
the dampening means comprises a first damper having a first constraint element and a first visco-elastic layer provided on a surface of the first constraint element;
the first constraint element is connected to the annular end plate through the first visco-elastic layer; and
the outer rotor is supported to the support frame exclusively at one end by a bearing located at an opposed end of the outer rotor relative to the annular end plate.

13. An electric machine as claimed in claim 12, wherein the first constraint element is a monolithic element.

14. An electric machine as claimed in claim 12, wherein the first constraint element is connected to the outer rotor exclusively through the first visco-elastic layer.

15. An electric machine as claimed in claim 12, wherein the first constraint element is a monolithic element connected to the outer rotor exclusively through the first visco-elastic layer.
